(19) United States
(12) Patent Application Publication
(10) Pub. No.: US 2014/0012765 A1
(43) Pub. Date: Jan. 9, 2014

(54) PROVIDING RECYCLING PRODUCT PACKAGING

(71) Applicant: Ezekiel Kruglick, Poway, CA (US)

(72) Inventor: Ezekiel Kruglick, Poway, CA (US)

(73) Assignee: Empire Technology Development LLC, Wilmington, DE (US)

(21) Appl. No.: 13/884,262

(22) PCT Filed: Jul. 2, 2012
(86) PCT No.: PCT/US12/45191

§ 371 Date: Sep. 12, 2013

(51) Int. Cl. G06Q 10/00

(52) U.S. Cl. CPC G06Q 10/30
USPC 705/308

(57) ABSTRACT

Technologies are generally described for allowing merchants to provide packaging for ready recyclable items. Consumers may list one or more products associated with special recycling on a registry for indicating the consumer has products that need to be recycled. When a new order for a new product is received from the consumer by a merchant, the merchant may identify a recyclable product in the registry. The merchant or a third party entity may select packaging for the new product that may be compatible with both the new product and the recyclable product if those two are not similar in size and shape. The merchant/third party entity may then ship the new product to the consumer in the selected packaging with a return shipping label, and the consumer may repackage and send the recyclable product in the provided packaging to a recycler for proper recycling.

### BACKGROUND

Unless otherwise indicated herein, the materials described in this section are not prior art to the claims in this application and are not admitted to be prior art by inclusion in this section.

In a consumer environment, consumers may use multiple products that may be recycled rather than disposed of when the consumer has finished using the products. Some products require special recycling processes, and additionally, some product may be returned to merchants or manufacturers for recycling so that they can recycle and reuse the materials to save money and resources. Some example products, which may be recycled, may include ink and toner cartridges, electronic equipment, appliances, miscellaneous household items, cooking oil, scrap metals, batteries, textiles, paper for shredding, and large plastic and rubber items. In order to recycle and return the used products, a merchant may supply shipping materials and packaging materials to the consumer so that consumer can repackage the product for returning the product to the merchant for recycling. Providing special packaging with prepaid shipping labels may be expensive for merchants, especially when the consumers fail to return the recyclable products to the merchant. When the recyclable products are returned to the merchant, the merchant may ensure that returned products are recycled properly, recovering valuable materials for use in new products, and diverting waste from landfills.

### SUMMARY

The present disclosure generally describes techniques for allowing merchants to provide packaging for ready recyclable items. According to some embodiments, the present disclosure describes a method for providing suitable packaging for ready recyclable items. The method may include allowing a consumer to register with a recyclable product registry, receiving identification information associated with a product ready for recycling at the recyclable product registry from the consumer, retrieving the identification information for the product ready for recycling from the recyclable product registry, and allowing a merchant receiving an order from the consumer for a new product to provide packaging compatible with a shape and a size of the product ready for recycling along with the new product such that the consumer can ship the product ready for recycling using the provided packaging.

According to other examples, the present disclosure also describes a server for maintaining a registry to provide packaging for ready recyclable items. The server may include a memory configured to store instructions, a communication module configured to facilitate communications with one or more consumer computing devices and one or more merchant servers, and a processor configured to execute a registry application in conjunction with the instructions stored in the memory. The registry application may be configured to allow a consumer to register with the registry, receive identification information at the registry from the consumer associated with a product ready for recycling, and forward the identification information to a merchant in order to provide packaging compatible with a shape and a size of the product ready for recycling along with a new product upon receiving an order from the consumer for the new product such that the consumer can ship the product ready for recycling using the provided packaging.

According to further examples, the present disclosure also describes a computer readable memory device with instructions stored thereon for providing packaging for ready recyclable items. The instructions may include allowing a consumer to register with a recyclable product registry, receiving identification information associated with a product ready for recycling at the recyclable product registry from the consumer, retrieving the identification information for the product ready for recycling from the recyclable product registry, and allowing a merchant receiving an order from the consumer for a new product to provide packaging compatible with a shape and a size of the product ready for recycling along with the new product such that the consumer can ship the product ready for recycling using the provided packaging.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 conceptually illustrates an example system for allowing merchants to provide packaging for ready recyclable items;

FIG. 2 illustrates an example cycle of an original product order, a new product order, and recycling of the original product in conjunction with the new product order;

FIG. 3 illustrates an example registry record for allowing merchants to provide packaging for ready recyclable items;

FIG. 4 illustrates a general purpose computing device, which may be used to maintain a registry for allowing merchants to provide packaging for ready recyclable items;

FIG. 5 is a flow diagram illustrating an example method that may be performed by a computing device such as the computing device in FIG. 4; and

FIG. 6 illustrates a block diagram of an example computer program product, all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to allowing merchants to provide packaging for ready recyclable items.

Briefly stated, technologies are generally described for allowing merchants to provide packaging for ready recyclable items. Consumers may list one or more products associated with special recycling on a registry for indicating that the consumer has products that need to be recycled. When a new order for a new product is received from the consumer by a merchant, the merchant may identify a recyclable product in the registry. The merchant or a third party entity may select packaging for the new product that may be compatible with both the new product and the recyclable product if those two are not similar in size and shape. The merchant/third party entity may then ship the new product to the consumer in the selected packaging with a return shipping label, and the consumer may repackage and send the recyclable product in the provided packaging to a recycler, the merchant, or the third party entity for recycling.

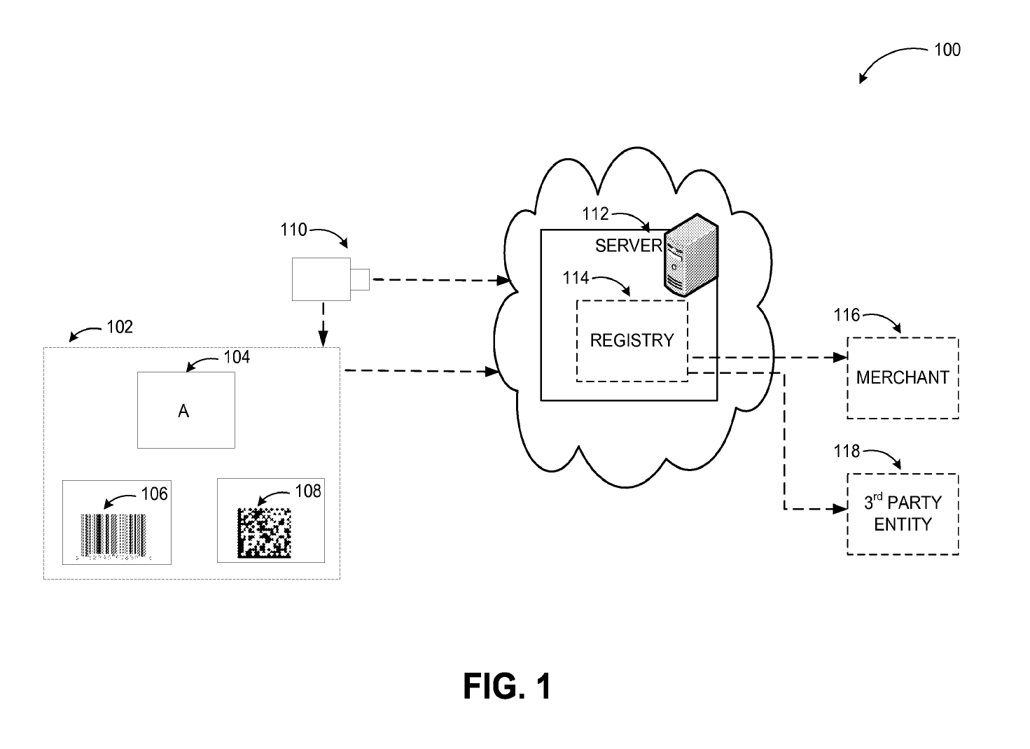

FIG. 1 conceptually illustrates an example system for allowing merchants to provide packaging for ready recyclable items, arranged in accordance with at least some embodiments described herein. As demonstrated in a diagram 100, a consumer may have multiple products 102, which the consumer may recycle rather than dispose of in the trash. Some products may need to undergo a special recycling process, which may be associated with the products being returned to a recycler for proper recycling. Examples of products, which may need to be returned for special recycling, may include ink and toner cartridges, electronic equipment, appliances, miscellaneous household items, cooking oil, scrap metals, batteries, textiles, paper for shredding, and large plastic and rubber items as some examples. Merchants or a party arranging the shipment of the product may supply shipping materials, including pre-paid shipping labels, boxes, and packing materials to the consumer so that consumer can repackage the products 102 for returning the products 102 to a recycler, the merchant, or the third party entity for recycling for proper recycling. Since shipping and packing materials supplied at purchase may be lost and/or discarded by the consumer, the merchants may waste a lot of money providing materials to the consumer.

In a system according to some embodiments, a merchant 116 may identify when a consumer has a product ready for recycling and may provide packaging suitable for returning the recyclable product when shipping a new product order to the consumer. The suitable packaging may also be provided by the third party entity 118 arranging shipment on behalf of a merchant. The consumer may list a recyclable product 104 on a recyclable product registry 114 which may be hosted on a server 112 and may be accessed by the merchant 116. The server 112 hosting the recyclable product registry 114 may be associated with the merchant 116 itself, and in another embodiment, the server 112 may be associated with the third party entity 118 responsible for hosting and providing the recyclable product registry 114 and the merchant 116 may have access to the recyclable product registry 114. The consumer may provide identification information associated with the recyclable product 104 to the recyclable product registry 114 so that the merchant 116 may identify that the consumer has a recyclable product 104 ready for recycling. When the consumer places a new order for a product from the merchant 116, the merchant 116 may access the recyclable product registry 114, and may identify if the consumer has listed any recyclable products on the recyclable product registry 114. If the merchant 116 identifies that the consumer has listed a recyclable product 104 as ready for recycling, the merchant 116 may identify packaging materials for shipping the new product to the consumer that may also be compatible for repackaging the recyclable product 104 for returning the recyclable product to the recycler, the third party entity 118, or the merchant 116.

In an example embodiment, the consumer may register the products 102 for recycling on the recyclable product registry 114 using multiple registration methods. For example, the consumer many access the recyclable product registry 114 hosted on the server 112 via a web browser on a client device such as a smart phone, tablet, and/or personal computer, and the consumer may manually enter identification information associated with the recyclable product 104. Identification information for the recyclable product 104 may include a UPC code associated with the recyclable product 104, a name and description of the recyclable product 104, or other identifying and descriptive information. In another example embodiment, identification information may be integrated with the recyclable product 104 as a bar code 106, a two dimensional QR code 108, and/or an RFID tag. Using a reader 110, which may be an RFID interrogator, a camera, a bar code scanner, and/or QR code reader, the consumer may scan the recyclable product 104 for automatically adding the recyclable product identification information to the recyclable product registry 114. In an example embodiment, the reader 110 may be an independent device, and in another example embodiment, the reader 110 may be an application or platform integrated with a smart phone or other device of the consumer.

In an additional embodiment, the consumer may register the recyclable product 104 on the recyclable product registry 114 at any time. For example, when the consumer has finished using a recyclable product 104, the consumer may register the product on the recyclable product registry 114. In another example, when the consumer first receives the product, the consumer may register the product on the registry, and when the product is ready for recycling, the consumer may update the registry to indicate that the product is now ready for recycling.

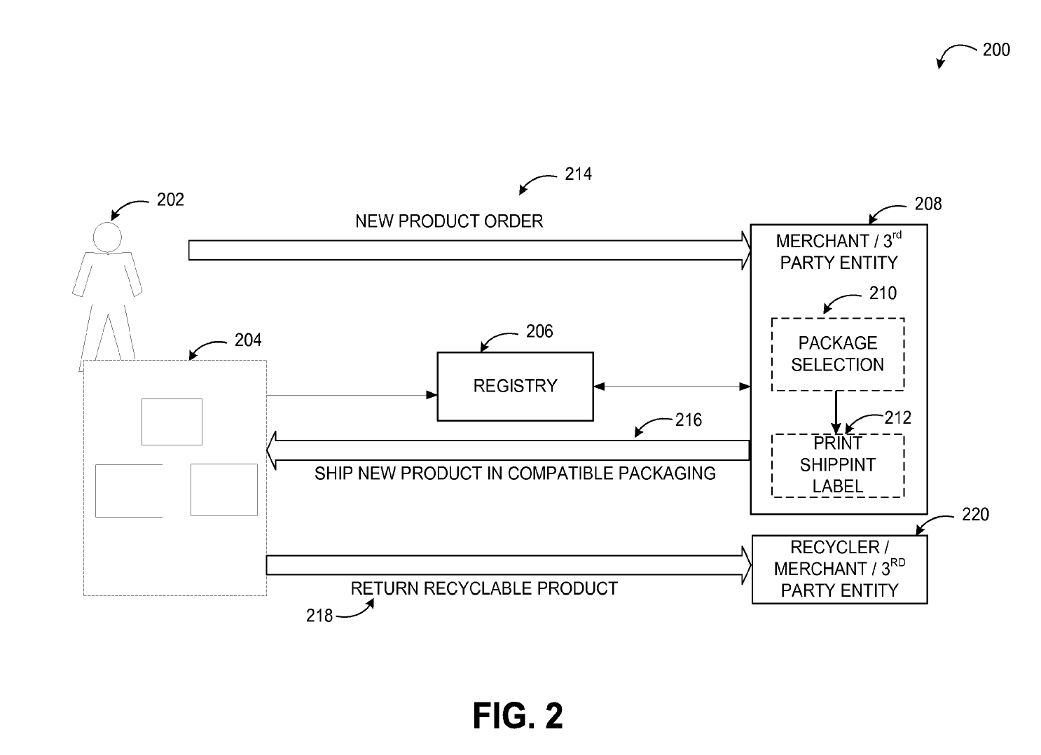

FIG. 2 illustrates an example cycle of an original product order, a new product order, and recycling of the original product in conjunction with the new product order, arranged in accordance with at least some embodiments described herein. As shown in a diagram 200, a consumer 202 may provide recyclable product information to a registry 206 for indicating one or more recyclable products 204 that the consumer 202 has ready for recycling. The registry 206 may be accessible by a merchant and/or third party entity 208 such that the merchant and/or third party entity 208 may identify one or more recyclable products 204 that are ready for recycling from the registry 206. The registry 206 may be hosted by the merchant and/or third party entity 208. In an additional embodiment, the consumer 202 may control the merchant's access to the product information in the registry 206 by specifying merchant access settings for information associated with the consumer 202 in the registry 206.

In an example embodiment, the consumer 202 may have one or more recyclable products 204 that the consumer 202 has finished using and that are ready to be recycled. The consumer 202 may register the one or more recyclable products 204 on the registry 206 via a manual entry and/or via an automatic scanning of the products in order to indicate that the consumer has recyclable products 204 that need to be recycled. When the consumer 202 registers the one or more recyclable products 204 on the registry 206, identification information associated with the one or more recyclable products 204, such as an item name, item number, identification code, and description, may be stored in the registry 206 along with the consumer's identification information.

In an example scenario, the consumer 202 may place a new order 214 from the merchant and/or third party entity 208 for a new product. When the merchant and/or third party entity 208 receives the new order 214, the merchant and/or third party entity 208 may consult the registry 206 containing the identification information for the one or more recyclable products 204 to determine if the consumer 202 placing the new order has any recyclable products 204 registered on the registry. If the consumer 202 has registered one or more recyclable products 204 on the registry 206, the merchant and/or third party entity 208 may identify at least one recyclable product 204 associated with the consumer 202 that may be similar in shape and size of the new product so that the selected recycled product 204 may also fit in the new product packaging, and the merchant and/or third party entity 208 may select 210 packaging for shipping the new product to the consumer 202 that is compatible with the selected recyclable product 204.

In another embodiment, if the consumer 202 has two or more recyclable products 204 registered on the registry, the merchant and/or third party entity 208 may select packaging for the new product such that consumer 202 can send two or more of the recyclable products at the same time. Additionally, if the new product and the selected product for recycling are different in sizes, the merchant and/or third party entity 208 may provide extra packing materials, such as paper, packing foam and/or plastic materials for protecting a smaller sized product which may be packaged in a larger box for accommodating a larger sized product.

Upon selecting 210 packaging for the new product that may also be compatible for repackaging the selected recycled product, the merchant and/or third party entity 208 may ship 216 the new product to the consumer in selected compatible packaging. The merchant and/or third party entity 208 may additionally include a pre-printed return shipping label, which may be pre-paid, that the consumer 202 may affix to the packaging for sending the recycled product to the appropriate recycling destination. In some examples, the merchant who shipped the recycled product may provide the pre-paid label to the consumer 202 to incentivize the consumer to send the recycled product. In other examples, a third party entity (e.g., one who is managing orders and/or shipments for multiple merchants or one who is managing recycling for merchants) may provide the pre-paid label to the consumer as incentive and be compensated by the merchant for the recycled product or another party (e.g., a government entity or industry association incentivizing recycling of products) directly or in another manner. In further examples, the consumer may pay for the shipping. In yet other examples, the merchant providing the new product may send the pre-paid label and be compensated under an agreement between merchants or with a government entity. The merchant and/or third party entity 208 may also include packaging instructions for indicating to the consumer 202, which recyclable product should be repackaged in the provided packaging and sent to the indicated destination. Upon receiving the new product in the selected packaging, the consumer 202 may repackage the appropriate recyclable product in the packaging, attach the provided shipping labels, and send 218 the recycled product to a recycler, the merchant and/or third party entity 220 in the provided packaging.

In an additional embodiment, the merchant and/or third party entity 208 may allow the consumer 202 to repackage and return one or more recyclable products directly to a recycling facility rather than shipping the recyclable products to the merchant and/or third party entity 208. The merchant and/or third party entity 208 may identify if the consumer 202 may be located near a recycling facility, and may provide packaging and drop off instructions to the consumer 202. Further, the merchant 208 may be able to access the consumer's calendar and/or schedule, which may be on a calendar application, and/or a personal assistant program associated with the consumer 202, and the merchant and/or third party entity 208 may compare the list of the consumer's recyclable products 204 on the registry 206 with the consumer's schedule for determining whether the consumer 202 is planning to be in a vicinity of a recycling facility capable of accepting one or more products on the recycling list. If the merchant and/or third party entity 208 determines that the consumer 202 will be near a recycling facility, then the merchant 208 may alert the consumer about the recycling facility and may identify which of the consumer's recyclable products 204 that can be recycled at the recycling facility. The merchant and/or third party entity 208 may supply packaging materials to the consumer along with instructions for repackaging the recyclable product and returning the recyclable product to the recycling facility.

Further, the merchant and/or third party entity 208 may provide incentives to the consumer 202 in order to encourage the consumer 202 to participate in repackaging and recycling one or more of the consumer's recycling products 204. Example incentives may be rewards programs associated with the merchant, financial incentives, such as free shipping and discounts on new products, and other similar incentives that may encourage the consumer 202 to participate in registering recyclable products on the registry, and to repackage and return the recyclable products in the provided packaging. Alternatively, the extra packaging and service may be provided for a fee as a purchase add-on: “for 50 cents more get a box and label for returning X”.

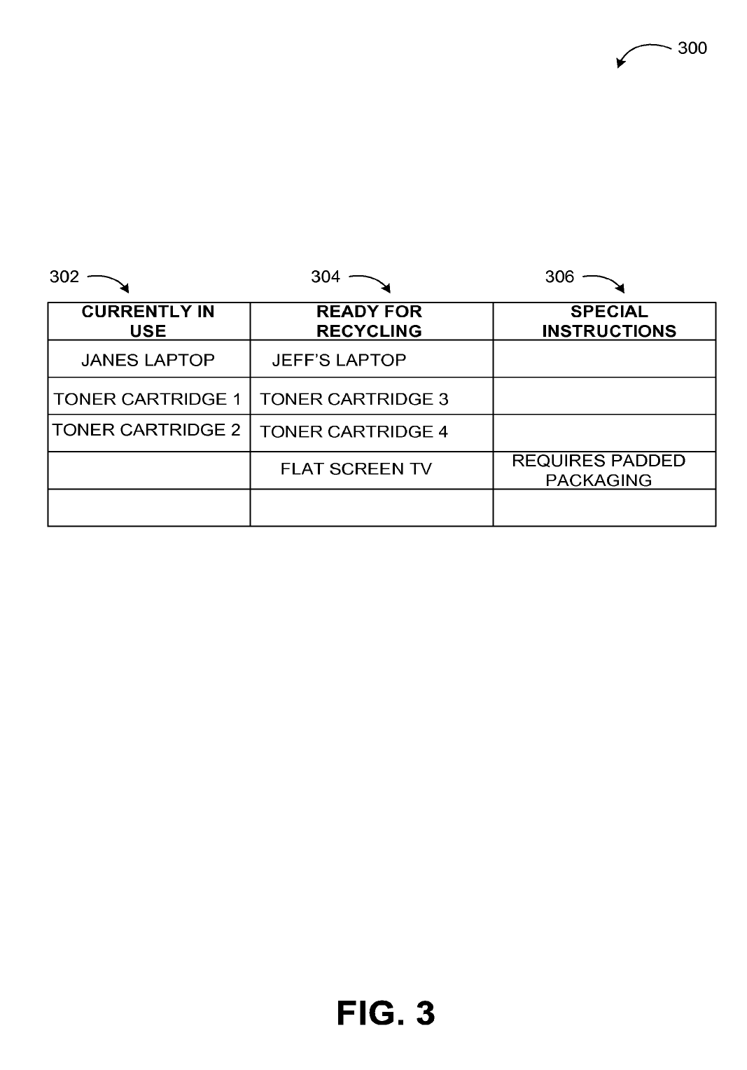

FIG. 3 illustrates an example registry record for allowing merchants to provide packaging for ready recyclable items, arranged in accordance with at least some embodiments described herein. As demonstrated in a diagram 300, a consumer may register one or more recyclable products on a registry for indicating that the products are ready to be recycled. In an example embodiment, when the consumer has finished with a recyclable product 104, the consumer may access the registry and may list the recyclable product as ready for recycling 304. The registry may include identifying information for the recyclable product, such as an item name, item number, shipping information, and description. The registry may also include a portion for indicating special instructions 306 for repackaging and recycling a product listed on the registry.

In another embodiment, the consumer may register the recyclable product 104 on the registry at any time, for example, when the consumer first receives the product, the consumer may register the product on the registry and indicate that the product is currently in use 302. When the product is ready for recycling 304, the consumer may update the registry by moving a recyclable product from the currently in use 302 portion of the registry to the ready for recycling 304 portion of the registry to indicate that the product is now ready for recycling 304. Additionally, a recyclable product on the registry may be automatically moved from the currently in use 302 portion of the registry to the ready for recycling 304 portion of the registry in response to receiving a new order from the consumer for a replacement and/or a new version of the product. An item may be both in use and ready for recycling if the consumer intends to recycle it when convenient.

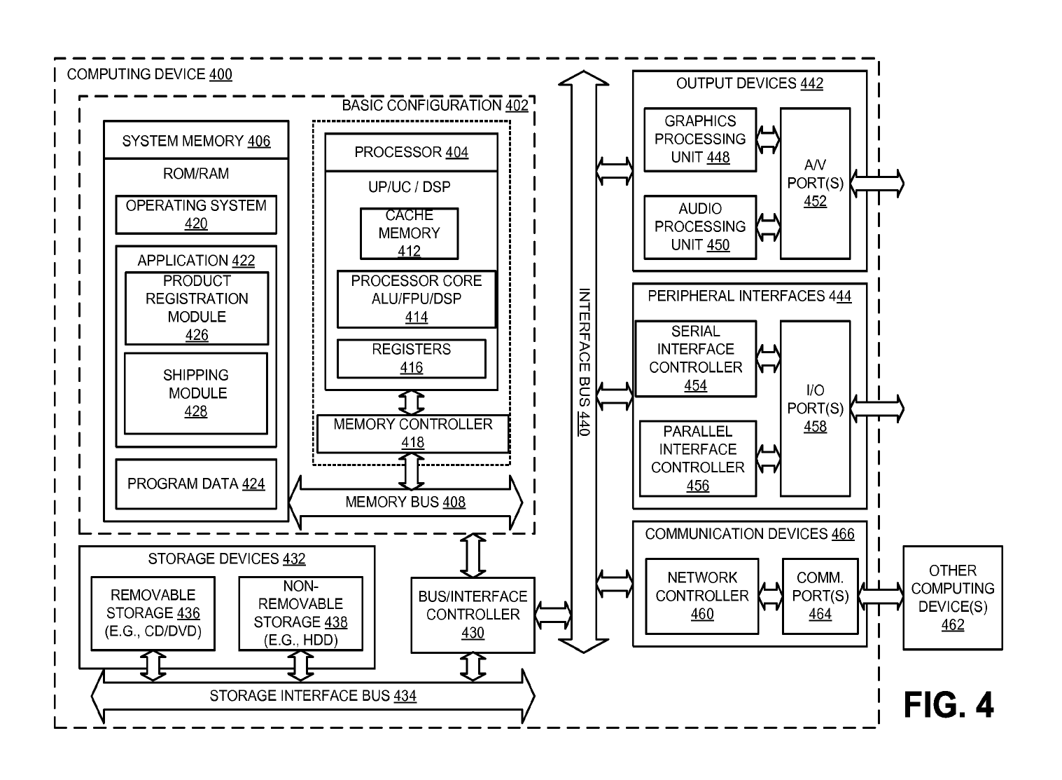

FIG. 4 illustrates a general purpose computing device, which may be used to maintain a registry for allowing merchants to provide packaging for ready recyclable items, arranged in accordance with at least some embodiments described herein. In a basic configuration 402, a computing device 400 typically includes one or more processors 404 and a system memory 406. A memory bus 408 may be used for communicating between a processor 404 and system a memory 406.

Depending on the desired configuration, the processor 404 may be of any type including but not limited to a microprocessor (μP), a microcontroller (μC), a digital signal processor (DSP), or any combination thereof The processor 404 may include one more levels of caching, such as a level cache memory 412, a processor core 414, and one or more registers 416. An example processor core 414 may include an arithmetic logic unit (ALU), a floating point unit (FPU), a digital signal processing core (DSP Core), or any combination thereof An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof The system memory 406 may include an operating system 420, one or more applications 422, and program data 424. The application 422 may include a product registration module 426 that is arranged to allow a consumer to list one or more products on a registry for indicating that the consumer has products ready for recycling. The application 422 may also include a shipping module 428 that is arranged to allow a merchant or a third party entity to select packaging for shipping a new product that is compatible with one or more recyclable products from the registry. Either of these examples may, in some embodiments, be realized as APIs that can be accessed by other entities and applications. Program data 424 may include recyclable product identification data, consumer data, and other similar data. The program data 424 may be useful in allowing the merchant to identify a product ready for recycling from the registry and to select packaging for a new product that is also compatible with the recyclable product. This described basic configuration 402 is illustrated in FIG. 4 by those components within the inner dashed line.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. Example output devices 442 include a graphics processing unit 448 and an audio processing unit 450, which may be configured to communicate to various external devices such as a display or speakers via one or more AN ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 400 may also be implemented as a personal computer including both laptop computer and non-laptop computer configurations. Moreover the computing device 400 may be implemented as a networked system or as part of a general purpose or specialized server.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated.

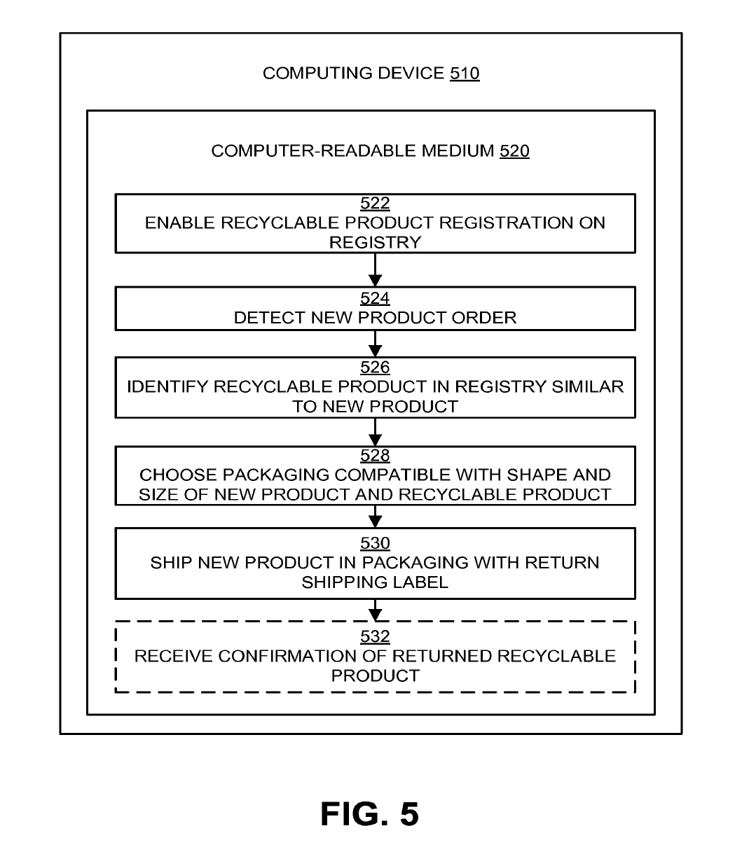

FIG. 5 is a flow diagram illustrating an example method that may be performed by a computing device such as the computing device in FIG. 4, arranged in accordance with at least some embodiments described herein.

Example methods may include one or more operations, functions or actions as illustrated by one or more of blocks 522, 524, 526 and/or 528. The operations described in blocks 522 through 528 may also be stored as computer-executable instructions in a computer-readable medium such as a computer-readable medium 520 of a computing device 510.

A process for allowing merchants to provide packaging for ready recyclable items may begin with block 522, “ALLOW RECYCLABLE PRODUCT REGISTRATION ON REGISTRY.” At block 522, one or more products may be listed on a registry for indicating that the consumer has products ready for recycling.

Block 522 may be followed by block 524, “DETECT NEW PRODUCT ORDER.” At block 524, a merchant and/or a third party entity may receive an order from the consumer for a new product.

Block 524 may be followed by block 526, “IDENTIFY RECYCLABLE PRODUCT IN REGISTRY SIMILAR TO NEW PRODUCT.” At block 526, upon receipt of an order for a new product, the merchant may consult the registry of products ready for recycling. The merchant and/or the third party entity may identify a recyclable product on the registry that is similar in shape and size to the new product.

Block 526 may be followed by block 528, “CHOOSE PACKAGING COMPATIBLE WITH SHAPE AND SIZE OF NEW PRODUCT AND RECYCLABLE PRODUCT.” At block 528, the merchant and/or the third party entity may select packaging for shipping the new product to the consumer that may also be compatible with the shape and size of the recyclable product.

Block 528 may be followed by block 530, “SHIP NEW PRODUCT IN PACKAGING WITH RETURN SHIPPING LABEL.” At block 530, the merchant and/or the third party entity may ship the new product to the consumer in the selected packaging that is also compatible with the shape and size of the recyclable product. The merchant and/or the third party entity may also include a prepared and pre-paid shipping label.

Block 530 may be followed by optional block 532, “RECEIVE CONFIRMATION OF RETURNED RECYCLABLE PRODUCT.” At optional block 532, the consumer may repackage the recyclable product in the packaging, affix the prepared shipping label, and return the packaging to a recycler. The merchant and/or the third party entity may receive a confirmation that the recyclable product has been returned for proper recycling.

The blocks included in the above described process are for illustration purposes. Allowing merchants to provide packaging for ready recyclable items may be performed by similar processes with fewer or additional blocks. In some examples, the blocks may be performed in a different order. In some other examples, various blocks may be eliminated. In still other examples, various blocks may be divided into additional blocks, or combined together into fewer blocks. Although illustrated as sequentially ordered operations, in some implementations the various operations may be performed in a different order, or in some cases various operations may be performed at substantially the same time.

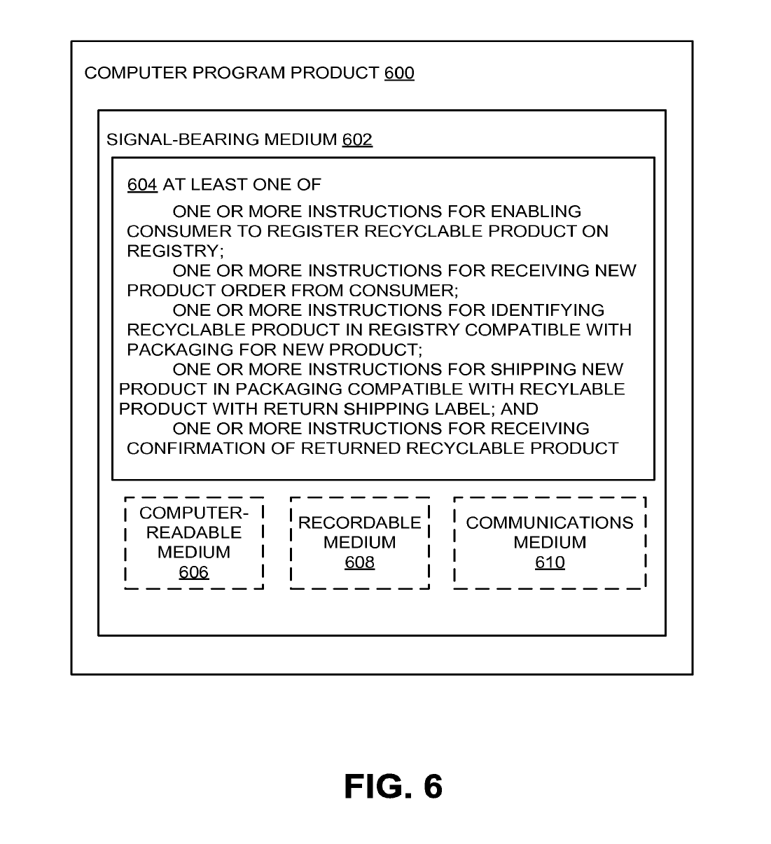

FIG. 6 illustrates a block diagram of an example computer program product, all arranged in accordance with at least some embodiments described herein. In some examples, as shown in FIG. 6, a computer program product 600 may include a signal bearing medium 602 that may also include machine readable instructions 604 that, when executed by, for example, a processor, may provide the functionality described above with respect to FIG. 4 and FIG. 5. Thus, for example, referring to the processor 404, the product registration module 426 and the shipping module 428 may undertake one or more of the tasks shown in FIG. 6 in response to the instructions 604 conveyed to the processor 404 by the signal bearing medium 602 to perform actions associated with allowing merchants to provide packaging for ready recyclable items as described herein. Some of those instructions may include allowing a consumer to register recyclable products on a registry, receiving a new product order from the consumer, identifying a recyclable product in the registry that is compatible with packaging for the new product, shipping the new product to the consumer in packaging compatible with the recyclable product with a return shipping label, and receiving confirmation of the returned recyclable product.

In some implementations, the signal bearing medium 602 depicted in FIG. 6 may encompass a computer-readable medium 606, such as, but not limited to, a hard disk drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). Thus, for example, the program product 600 may be conveyed to one or more modules of the processor 404 by an RF signal bearing medium, where the signal bearing medium 602 is conveyed by a wireless communications medium 610 (e.g., a wireless communications medium conforming with the IEEE 802.11 standard).

The present disclosure describes a method for providing suitable packaging for ready recyclable items. The method may include allowing a consumer to register with a recyclable product registry, receiving identification information associated with a product ready for recycling at the recyclable product registry from the consumer, retrieving the identification information for the product ready for recycling from the recyclable product registry, and allowing a merchant receiving an order from the consumer for a new product to provide packaging compatible with a shape and a size of the product ready for recycling along with the new product such that the consumer can ship the product ready for recycling using the provided packaging.

According to some examples, the method may include receiving the identification information from the consumer through at least one of: scanning of a barcode, scanning of a QR code, interrogation of a Radio Frequency Identification (RFID) tag, image recognition, or manual entry. The barcode, the QR code, and/or the RFID tag may be affixed to the product ready for recycling. The manual entry may include entry of the identification information through one of a smartphone app and a browser interface associated with the recyclable product registry.

According to some examples, the method may include selecting the packaging to accommodate the new product and the product ready for recycling. The method may include providing a shipping label for the product ready for recycling along with the new product. The recyclable product registry may be hosted by the merchant shipping the new product. The recyclable product registry may be hosted by an independent entity and is accessible by the merchant shipping the new product, for example via a third party authorization system.

According to some examples, the method may include allowing the consumer to give revocable and limited access to the merchant for information associated with the consumer in the recyclable product registry. The method may include selecting the packaging for the new product such that the consumer can ship multiple products ready for recycling at the same time. The method may also include providing a recycling list to the consumer through the registry for recyclable products, wherein the recycling list includes a first portion indicating products still in use and a second portion indicating products ready to be recycled.

According to other examples, the method may include allowing the consumer to provide the identification information by moving a product from the first portion of the recycling list to the second portion of the recycling list. The method may include comparing the recycling list to a personal assistant program associated with the consumer, determining whether the consumer is planning to be in a vicinity of a recycling facility capable of accepting one or more products on the recycling list, and alerting the consumer about the recycling facility and the one or more products that can be recycled at the recycling facility.

According to further examples, the method may include automatically indicating a product as ready for recycling in response to receiving an order from the consumer for a new version of the product. The method may also include providing an incentive to the consumer to one or more of: participate in the registry and ship the product ready for recycling in the provided packaging.

The present disclosure also describes a server for maintaining a registry to provide packaging for ready recyclable items. The server may include a memory configured to store instructions, a communication module configured to facilitate communications with one or more consumer computing devices and one or more merchant servers, and a processor configured to execute a registry application in conjunction with the instructions stored in the memory. The registry application may be configured to allow a consumer to register with the registry, receive identification information at the registry from the consumer associated with a product ready for recycling, and forward the identification information to a merchant in order to provide packaging compatible with a shape and a size of the product ready for recycling along with a new product upon receiving an order from the consumer for the new product such that the consumer can ship the product ready for recycling using the provided packaging.

According to some examples, the registry application may be further configured to receive the identification information from the consumer through at least one of: scanning of a barcode, scanning of a QR code, interrogation of a Radio Frequency Identification (RFID) tag, image recognition, or manual entry. The barcode, the QR code, and/or the RFID tag may be affixed to the product ready for recycling. The manual entry may include entry of the identification information through one of a smartphone app and a browser interface associated with the recyclable product registry. The packaging may be selected to accommodate the new product and the product ready for recycling. A shipping label may be provided for the product ready for recycling along with the new product. The recyclable product registry may be hosted by the merchant shipping the new product. The recyclable product registry may be hosted by an independent entity and is accessible by the merchant shipping the new product via a third party authorization system.

According to some examples, the registry application may be further configured to allow the consumer to give revocable and limited access to the merchant for information associated with the consumer in the recyclable product registry. The packaging for the new product may be selected such that the consumer can ship multiple products ready for recycling at the same time.

According to some examples, the registry application may be further configured to provide a recycling list to the consumer through the registry for recyclable products, wherein the recycling list includes a first portion indicating products still in use and a second portion indicating products ready to be recycled. The registry application may be further configured to allow the consumer to provide the identification information by moving a product from the first portion of the recycling list to the second portion of the recycling list. The registry application may be further configured to compare the recycling list to a personal assistant program associated with the consumer, determine whether the consumer is planning to be in a vicinity of a recycling facility capable of accepting one or more products on the recycling list, and alert the consumer about the recycling facility and the one or more products that can be recycled at the recycling facility.

According to other examples, the registry application may be further configured to automatically indicate a product as ready for recycling in response to receiving an order from the consumer for a new version of the product. The registry application may be further configured to provide an incentive to the consumer to one or more of: participate in the registry and ship the product ready for recycling in the provided packaging.

The present disclosure also describes a computer readable memory device with instructions stored thereon for providing packaging for ready recyclable items. The instructions may include allowing a consumer to register with a recyclable product registry, receiving identification information associated with a product ready for recycling at the recyclable product registry from the consumer, retrieving the identification information for the product ready for recycling from the recyclable product registry, and allowing a merchant receiving an order from the consumer for a new product to provide packaging compatible with a shape and a size of the product ready for recycling along with the new product such that the consumer can ship the product ready for recycling using the provided packaging.

According to some examples, the instructions may include receiving the identification information from the consumer through at least one of: scanning of a barcode, scanning of a QR code, interrogation of a Radio Frequency Identification (RFID) tag, image recognition or manual entry. The barcode, the QR code, and/or the RFID tag may be affixed to the product ready for recycling. The manual entry may include entry of the identification information through one of a smartphone app and a browser interface associated with the recyclable product registry.

According to some examples, the instructions may include selecting the packaging to accommodate the new product and the product ready for recycling. The method may include providing a shipping label for the product ready for recycling along with the new product. The recyclable product registry may be hosted by the merchant shipping the new product. The recyclable product registry may be hosted by an independent entity and is accessible by the merchant shipping the new product via a third party authorization system.

According to some examples, the instructions may include allowing the consumer to give revocable and limited access to the merchant for information associated with the consumer in the recyclable product registry. The method may include selecting the packaging for the new product such that the consumer can ship multiple products ready for recycling at the same time. The method may also include providing a recycling list to the consumer through the registry for recyclable products, wherein the recycling list includes a first portion indicating products still in use and a second portion indicating products ready to be recycled.

According to other examples, the instructions may include allowing the consumer to provide the identification information by moving a product from the first portion of the recycling list to the second portion of the recycling list. The method may include comparing the recycling list to a personal assistant program associated with the consumer, determining whether the consumer is planning to be in a vicinity of a recycling facility capable of accepting one or more products on the recycling list, and alerting the consumer about the recycling facility and the one or more products that can be recycled at the recycling facility.

According to further examples, the instructions may include automatically indicating a product as ready for recycling in response to receiving an order from the consumer for a new version of the product. The method may also include providing an incentive to the consumer to one or more of: participate in the registry and ship the product ready for recycling in the provided packaging.

### EXAMPLES

Following are illustrative examples of how some embodiments may be implemented, and are not intended to limit the scope of embodiments in any way.

### Example 1

### Recycling of Consumable Products through Online Registry

A consumer may use a toner cartridge in a printer at the consumer's home. When the toner cartridge is empty and the consumer is ready to dispose of the old toner cartridge, the user may access an online registry via a web browser on the consumer's smartphone. The consumer may scan a bar code on the toner cartridge using a bar code scanner application installed on the consumer's smartphone. The specific identification information for the old toner cartridge may be added to the registry for indicating that the toner cartridge is ready to recycle. The consumer may place an order to a supplier online for a new child's toy which may be similar in shape and size to the toner cartridge. When the supplier receives the new order, the supplier may consult the registry to determine if the consumer has registered one or more products for recycling. The supplier may identify that the consumer has an old toner cartridge that needs to be recycled that is similar in shape and size to the new toy order, and the supplier may select packaging for shipping the new toner cartridge to the consumer that will also accommodate the new toy. The supplier may also print a return shipping label and may include the shipping label with an address for a toner cartridge recycling facility, as well as packaging instructions, in the packaging when shipping the new toner cartridge to the consumer. When the consumer receives the new toy, the consumer may repackage the old toner cartridge in the packaging according to the packing instructions, affix the return shipping label to the packaging, and ship the old toner cartridge in the packaging to the recycling facility. The recycling facility may receive the old toner cartridge and may recycle the old toner cartridge appropriately.

### Example 2

### Recycling of Multiple Products through Manual Entry in an Online Registry

A consumer may have an old car battery, a broken personal computing device, and an old rubber bicycle tire that need to be recycled. The consumer may access an online registry via a web browser on the consumer's personal computing device and may manually add each of the items to a ready for recycling portion of the online registry. The consumer may place an order online to a merchant for a new television. When the merchant receives the new order, the merchant may consult the registry to determine if the consumer has registered one or more products for recycling. The merchant may identify that the consumer has old car battery, a broken personal computing device, and an old rubber bicycle tire that need to be recycled. The merchant may select packaging for shipping the television to the consumer that will also accommodate at least one of the recyclable products. The merchant may determine that the television box will accommodate the broken personal computing device, the rubber bicycle tire, but not the car battery, so the merchant may ship the television with instructions to repackage the broken personal computing device and the rubber bicycle tire, along with a return shipping label. Alternatively the merchant may select a larger box and may ship the television with instructions to repackage the broken personal computing device, the rubber bicycle tire, and the car battery. When the consumer receives the television, the consumer may repackage the recyclable products in the packaging according to the packing instructions, affix the return shipping label to the packaging, and return the recyclable products to a recycling facility indicated on the return shipping label.

### Example 3

### Use of Consumer Applications to Assist Recycling through an Online Registry

A consumer may list a gallon of cooking oil on a recyclable products registry for indicating that the cooking oil is ready to be recycled. The consumer may synchronize a personal calendar on the consumer's personal smart phone and/or personal assistant device with the registry a recyclable products registry. The consumer may place an order for more cooking oil from an online merchant. The online merchant may access the registry and identify that the consumer needs to recycle the gallon of used cooking oil. The online merchant may access the consumer's personal calendar and may determine that the consumer has an appointment located within a close vicinity of a recycling facility capable of accepting used cooking oil. The online merchant may ship the new cooking oil to the consumer in a package that will accommodate the used cooking oil, and may also include instructions in the packaging informing the consumer to repackage the used cooking oil in the packaging and to drop off the used cooking oil at the recycling facility when the consumer goes to his appointment.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented using any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for providing suitable packaging for ready recyclable items, the method comprising:
allowing a consumer to register with a recyclable product registry;
receiving identification information associated with one or more products ready for recycling at the recyclable product registry from the consumer;
retrieving the identification information for the products ready for recycling from the recyclable product registry;
providing a recycling list to the consumer through the recyclable product registry products, wherein the recycling list includes a first portion indicating products still in use and a second portion indicating products ready to be recycled; and
allowing a merchant receiving an order from the consumer for a new product to select packaging compatible with a shape and a size of the new product and multiple products ready for recycling and to provide the new product to the consumer in the selected packaging such that the consumer is permitted to ship the multiple products ready for recycling using the provided packaging.

2. The method of claim 1, further comprising:
receiving the identification information from the consumer through at least one of: scanning of a barcode, scanning of a QR code, image recognition, interrogation of a Radio Frequency Identification (RFID) tag, or manual entry.

3. The method of claim 1, wherein the at least one of the barcode, the QR code, or the RFID tag are affixed to the product ready for recycling.

4. The method of claim 1, wherein the manual entry includes entry of the identification information through one of a smartphone app and a browser interface associated with the recyclable product registry.

5. (canceled)

6. The method of claim 1, further comprising:
allowing delivery of a shipping label for the product ready for recycling along with the new product.

7. The method of claim 1, wherein the recyclable product registry is hosted by the merchant shipping the new product.

8. The method of claim 1, wherein the recyclable product registry is hosted by an independent entity and is accessible by the merchant shipping the new product via a third party authorization system.

9. The method of claim 8, further comprising:
allowing the consumer to give revocable and limited access to the merchant for information associated with the consumer in the recyclable product registry.

10. (canceled)

11. (canceled)

12. (canceled)

13. The method of claim 1, further comprising:
comparing the recycling list to a personal assistant program associated with the consumer;
determining whether the consumer is planning to be in a vicinity of a recycling facility capable of accepting one or more products on the recycling list; and
alerting the consumer about the recycling facility and the one or more products that can be recycled at the recycling facility.

14. (canceled)

15. (canceled)

16. A server for maintaining a registry to provide packaging for ready recyclable items, the server comprising:
a memory configured to store instructions;
a communication module configured to facilitate communications with one or more consumer computing devices and one or more merchant servers; and
a processor configured to execute a registry application in conjunction with the instructions stored in the memory, wherein the registry application is configured to:
allow a consumer to register with the registry;
receive identification information at the registry from the consumer associated with a product ready for recycling;
provide a recycling list to the consumer through the registry for recyclable products, wherein the recycling list includes a first portion indicating products still in use and a second portion indicating products ready to be recycled; and
forward the identification information to a merchant in order to select packaging compatible with a shape and a size of the new product and multiple products ready for recycling upon receiving an order from the consumer for the new product such that the consumer is permitted to ship the multiple products ready for recycling using the provided packaging.

17. (canceled)

18. (canceled)

19. (canceled)

20. (canceled)

21. (canceled)

22. (canceled)

23. The server of claim 16, wherein the registry is hosted by an independent entity and is accessible by the merchant shipping the new product via a third party authorization system.

24. The server of claim 23, wherein the registry application is further configured to:
allow the consumer to give revocable and limited access to the merchant for information associated with the consumer in the recyclable product registry.

25. The server of claim 16, wherein the packaging for the new product is selected such that the consumer can ship multiple products ready for recycling at the same time.

26. (canceled)

27. (canceled)

28. (canceled)

29. The server of claim 16, wherein the registry application is further configured to:
automatically indicate a product as ready for recycling in response to receiving an order from the consumer for a new version of the product.

30. The server of claim 16, wherein the registry application is further configured to:
provide an incentive to the consumer to one or more of: participate in the registry and ship the product ready for recycling in the provided packaging.

31. A computer readable memory device with instructions stored thereon for providing packaging for ready recyclable items, the instructions comprising:
allowing a consumer to register with a recyclable product registry;
receiving identification information associated with a product ready for recycling at the recyclable product registry from the consumer;
retrieving the identification information for the product ready for recycling from the recyclable product registry; and
allowing a merchant receiving an order from the consumer for a new product to select packaging compatible with a shape and a size of the new product and multiple products ready for recycling and to provide the new product to the consumer in the selected packaging such that the consumer is permitted to ship the one or more products ready for recycling using the provided packaging.

32. (canceled)

33. (canceled)

34. The computer readable memory device of claim 31, wherein the manual entry includes entry of the identification information through one of a smartphone app and a browser interface associated with the recyclable product registry.

35. (canceled)

36. The computer readable memory device of claim 31, wherein the instructions further comprise:
allowing delivery of a shipping label for the product ready for recycling along with the new product.

37. The computer readable memory device of claim 31, wherein the recyclable product registry is hosted by the merchant shipping the new product.

38. The computer readable memory device of claim 31, wherein the recyclable product registry is hosted by an independent entity and is accessible by the merchant shipping the new product via a third party authorization system.

39. (canceled)

40. (canceled)

41. The computer readable memory device of claim 31, wherein the instructions further comprise:
providing a recycling list to the consumer through the registry for recyclable products, wherein the recycling list includes a first portion indicating products still in use and a second portion indicating products ready to be recycled.

42. The computer readable memory device of claim 31, wherein the instructions further comprise:
allowing the consumer to provide the identification information by moving a product from the first portion of the recycling list to the second portion of the recycling list.

43. The computer readable memory device of claim 31, wherein the instructions further comprise:
comparing the recycling list to a personal assistant program associated with the consumer;
determining whether the consumer is planning to be in a vicinity of a recycling facility capable of accepting one or more products on the recycling list; and
alerting the consumer about the recycling facility and the one or more products that can be recycled at the recycling facility.

44. (canceled)

45. (canceled)
